(19) United States
(12) Patent Application Publication
(10) Pub. No.: US 2026/0310395 A1
(43) Pub. Date: Oct. 8, 2026

(54) Phone and Touchscreen Monitor Interface

(71) Applicant: Optelec Holding B.V., Barendrecht (NL)

(72) Inventors: Bart Pieter Zwager, Clearwater, FL (US); Sheng-Sung Jian, Clearwater, FL (US)

(21) Appl. No.: 19/461,266

(22) Filed: Jan. 27, 2026

Related U.S. Application Data
(60) Provisional application No. 63/749,966, filed on Jan. 27, 2025.

(51) Int. Cl. G06F 3/14; G06F 3/041

(52) U.S. Cl. CPC G06F 3/1423; G06F 3/0416

(57) ABSTRACT

A system for accessing mobile device functions using a touchscreen monitor comprises a mobile device having a touchscreen display and processor, a touchscreen monitor with display panel and touch sensor, and a hub facilitating communication between devices. The hub receives image data from the mobile device and communicates it to the touchscreen monitor for enlarged display presentation. Touch inputs detected on the touchscreen monitor are transmitted back through the hub to control mobile device functions. The system includes alignment correction algorithms that translate touch coordinates between devices with different aspect ratios and orientations. Portrait and landscape mode configurations are supported with coordinate translation formulas and lookup tables containing alignment parameters for different mobile device models and display panel types. The system enables users with visual impairments to interact with mobile device applications through larger, more accessible touchscreen interfaces while maintaining precise touch coordinate accuracy.

### CLAIM OF PRIORITY

This application claims priority of Provisional Patent Application Ser. No. 63/749,966, titled “Phone and Touchscreen Monitor Interface,” and filed on Jan. 27, 2025, the contents of which are incorporated by reference herein.

### BACKGROUND

Image magnifiers are used by vision-impaired individuals for assistance in reading printed material such as books and documents. An unexpected use for image magnifiers has been to zoom on the display of a smartphone. Users have found image magnifiers useful for viewing enlarged images of the smartphone display provided by apps (e.g. banking apps), social media, and messaging. A camera in the image magnifier captures the image of the smartphone display and projects the enlarged image on a larger monitor.

One limitation of using an image magnifier as viewer to project a larger smartphone display is the difficulty in interacting with the small smartphone touch screen despite the enlarged image on the monitor. The user interacts with the phone by touching the screen of the phone, while viewing the enlarged image of the phone on the monitor of the image magnifier. There is a disconnect between viewing the large monitor display screen but physically interacting with the small phone screen for feedback.

A screen mirroring feature currently exists to connect a smartphone to an external monitor for display output. The phone is linked with a cable (and sometimes an adapter in between is necessary) to show the phone screen on the monitor of the magnifier. With HDMI input on the desktop magnifier, this connecting is possible now. This results in a better image on the big monitor compared to a live camera image that magnifies the pixels of the phone screen but the phone interaction is very difficult as there is no hand-eye coordination. A user must look on his or her phone to interact and may miss the result of the interaction. A user cannot view the phone and magnifier screen in parallel.

Some phones allow mouse or touchscreen connectivity. Many desktop magnifiers have touchscreens. Many other computing devices use touchscreens as a user interface device. There is a need in the art for a feature that allows a user to use a monitor touch screen to control the functions (and display) of a smartphone.

### SUMMARY

According to one aspect, a system for accessing mobile device functions using a touchscreen monitor comprises a mobile device having a touchscreen display and a processor configured to execute software applications, a touchscreen monitor having a display panel and a touch sensor configured to detect user touch inputs on the touchscreen monitor, and a hub configured to communicate with the mobile device and the touchscreen monitor, wherein the hub is configured to receive image data from the mobile device defining an image displayed on the mobile device touchscreen display, communicate the image data to the touchscreen monitor for display on the display panel of the touchscreen monitor, receive touch data from the touchscreen monitor indicating a location of a user touch input on the touchscreen monitor, and communicate the touch data to the mobile device to control functions of the mobile device. This enables users to interact with mobile device applications through a larger touchscreen interface while viewing enlarged content, improving accessibility and usability.

According to an embodiment, the hub comprises a USB-C connector configured to connect to the mobile device. This provides a standardized connection interface that supports both data transmission and power delivery.

According to an embodiment, the hub comprises a USB controller configured to implement a Human Interface Device touch panel interface over a USB 2.0 interface. This enables efficient communication of touch input data between the touchscreen monitor and the mobile device.

According to an embodiment, the hub comprises a high speed switch configured to output an HDMI signal from an alternative mode interface and an HDMI framer configured to format the image data for transmission to the touchscreen monitor. This allows high-quality video transmission from the mobile device to the external display.

According to an embodiment, the system further comprises a mux scaler configured to translate an aspect ratio of the mobile device display to an aspect ratio of the touchscreen monitor. This ensures proper display formatting when the mobile device and touchscreen monitor have different aspect ratios.

According to an embodiment, the mux scaler is configured to scale the image data to fit a size of the display panel of the touchscreen monitor. This optimizes the display content to utilize the full screen area of the touchscreen monitor.

According to an embodiment, the touchscreen monitor comprises a rotation sensor configured to detect rotation of the touchscreen monitor between portrait and landscape orientations. This enables automatic adaptation to different viewing orientations.

According to an embodiment, the hub is configured to communicate orientation information from the rotation sensor to the mobile device via a data communication channel. This allows the mobile device to adjust its display output based on the touchscreen monitor's orientation.

According to an embodiment, the hub is configured to detect orientation changes between landscape and portrait modes and automatically switch between corresponding alignment correction algorithms. This ensures accurate touch input mapping regardless of screen orientation.

According to an embodiment, the hub is configured to translate the user touch input location on the touchscreen monitor to a corresponding touch location on the mobile device based on a difference in aspect ratio between the touchscreen monitor and the mobile device. This provides accurate touch coordinate mapping between devices with different screen dimensions.

According to an embodiment, the mobile device is configured to translate the touch data received from the hub to a touch location on the mobile device touchscreen display based on a difference in aspect ratio between the touchscreen monitor and the mobile device. This enables the mobile device to process touch inputs from the external touchscreen monitor accurately.

According to an embodiment, the hub is configured to detect a model of the mobile device and apply alignment correction based on the detected model to compensate for differences between display resolution and touch panel resolution. This addresses device-specific alignment issues that can occur with different mobile device models.

According to an embodiment, the alignment correction comprises applying scaling factors to translate touch coordinates from the touchscreen monitor to corresponding coordinates on the mobile device based on predetermined alignment parameters for the detected model. This provides precise coordinate mapping tailored to specific device characteristics.

According to an embodiment, the predetermined alignment parameters include dimension values A, B, C, and D that define active display areas and offset values for different mobile device models and display panel types. This enables accurate touch mapping by accounting for device-specific display characteristics and black border areas.

According to an embodiment, the hub is configured to apply different alignment correction algorithms based on display panel type, including Full High Definition (FHD), Quad High Definition (QHD), and 4K display panels. This ensures compatibility with various display resolutions and maintains accurate touch input mapping.

According to an embodiment, the alignment correction algorithm translates touch coordinates (a, b) on the touchscreen monitor to coordinates (a′, b′) on the mobile device using the formula: a′=a and b′=[(b−D)×B]/C, where B, C, and D are predetermined values based on the mobile device model and display panel type. This provides a mathematical framework for precise coordinate transformation in landscape mode.

According to an embodiment, the hub comprises a lookup table containing alignment parameters for different mobile device models, the alignment parameters defining coordinate translation between the touchscreen monitor and respective mobile device models. This enables efficient storage and retrieval of device-specific calibration data.

According to an embodiment, the lookup table includes separate parameter sets for landscape mode and portrait mode orientations of the touchscreen monitor. This ensures accurate touch mapping in both screen orientations.

According to an embodiment, the hub is configured to apply portrait mode alignment correction using predetermined parameters N, O, P, and Q that define coordinate translation for portrait orientation of the touchscreen monitor. This provides specialized alignment correction for portrait mode operation.

According to an embodiment, the portrait mode alignment correction translates touch coordinates (a, b) on the touchscreen monitor to coordinates (a′, b′) on the mobile device using the formulas: a′=[(b−Q)×N]/P and b′=(a×O)/N. This provides mathematical precision for coordinate transformation in portrait orientation.

According to an embodiment, the hub comprises separate lookup tables for landscape mode and portrait mode orientations, each table containing alignment parameters specific to the respective orientation and mobile device model. This optimizes data organization and retrieval for orientation-specific calibration.

According to an embodiment, the portrait mode lookup table includes parameter sets for different display panel types including FHD (1920×1080), 2K QHD (2560×1440), and 4K QHD (3840×2160) displays in portrait orientation. This ensures compatibility with various display resolutions in portrait mode.

According to an embodiment, the hub stores portrait mode alignment tables containing different parameter values for a plurality of mobile device, each type having specific N, O, P, and Q values for accurate coordinate mapping. This provides comprehensive support for multiple device variants with tailored calibration parameters.

According to an embodiment, the hub is configured to identify inactive areas in the display content from the mobile device and map touch inputs in corresponding areas of the touchscreen monitor to null responses. This prevents unintended interactions in non-active display regions.

According to an embodiment, the hub is configured to handle touch inputs outside active display areas in portrait mode by reporting null responses for touches in black regions of the touchscreen monitor. This ensures that only touches within the active display area generate valid input responses.

According to an embodiment, the mobile device operates an Android operating system and receives the touch data as touch coordinates corresponding to a location on the mobile device touchscreen display. This provides native touch input support for Android devices.

According to an embodiment, the mobile device operates an iOS operating system and receives the touch data as mouse interface data using an iOS Assistive Touch function. This enables touch input compatibility with iOS devices through the assistive touch interface.

According to an embodiment, the touchscreen monitor is integrated with an image magnifying device. This provides enhanced accessibility for users with visual impairments by combining magnification and touch interface capabilities.

According to an embodiment, the system further comprises a cradle mounted on the image magnifying device and configured to hold the mobile device in a same orientation as the touchscreen monitor. This ensures synchronized orientation between the mobile device and touchscreen monitor for optimal user experience.

According to an embodiment, the hub is configured to apply a scaling algorithm to correct an offset between coordinates in an active display area of the touchscreen monitor and coordinates in an active touch area of the touchscreen monitor based on a detected mobile device model. This addresses misalignment issues that can occur with specific device models.

According to another aspect, a method for accessing mobile device functions using a touchscreen monitor comprises receiving, at a hub, image data from a mobile device, the image data defining an image displayed on a touchscreen display of the mobile device, communicating the image data from the hub to a touchscreen monitor for display on a display panel of the touchscreen monitor, detecting, by a touch sensor of the touchscreen monitor, a user touch input on the touchscreen monitor, generating touch data indicating a location of the user touch input on the touchscreen monitor, communicating the touch data from the touchscreen monitor to the hub, and communicating the touch data from the hub to the mobile device to control functions of the mobile device. This method enables seamless interaction with mobile device applications through an external touchscreen interface.

According to an embodiment, the method further comprises scaling the image data to translate an aspect ratio of the mobile device display to an aspect ratio of the touchscreen monitor. This ensures proper display formatting across different screen dimensions.

According to an embodiment, the method further comprises detecting rotation of the touchscreen monitor between portrait and landscape orientations and communicating orientation information to the mobile device to adjust the image data based on the detected rotation. This enables dynamic adaptation to orientation changes.

According to an embodiment, the method further comprises translating the location of the user touch input on the touchscreen monitor to a corresponding touch location on the mobile device based on a difference in aspect ratio between the touchscreen monitor and the mobile device. This provides accurate coordinate mapping between devices with different aspect ratios.

According to an embodiment, the method further comprises automatically switching between landscape mode and portrait mode alignment correction algorithms based on detected orientation of the touchscreen monitor, wherein portrait mode uses coordinate translation formulas: a′=[(b−Q)×N]/P and b′=(a×O)/N. This ensures accurate touch mapping in both orientations using appropriate mathematical transformations.

According to a further aspect, a method for correcting touch panel alignment in a mobile device interface system comprises detecting a model of a mobile device connected to a hub, determining display panel characteristics of a touchscreen monitor connected to the hub, selecting alignment correction parameters from a lookup table based on the detected mobile device model and display panel characteristics, receiving touch input coordinates from the touchscreen monitor, applying the selected alignment correction parameters to translate the touch input coordinates to corresponding coordinates on the mobile device, and transmitting the translated coordinates to the mobile device. This method provides precise touch coordinate correction tailored to specific device and display combinations.

According to an embodiment, the alignment correction parameters include scaling factors that account for differences in aspect ratio and resolution between the touchscreen monitor and the mobile device display. This ensures accurate coordinate transformation across different display specifications.

According to yet another aspect, a method for portrait mode touch panel alignment correction comprises detecting that a touchscreen monitor is in portrait orientation, selecting portrait mode alignment parameters N, O, P, and Q from a lookup table based on a detected mobile device model and display panel type, receiving touch coordinates (a, b) from the touchscreen monitor, applying portrait mode coordinate translation using the formulas: a′=[(b−Q)×N]/P and b′=(a×O)/N, and transmitting the translated coordinates (a′, b′) to the mobile device. This method provides specialized alignment correction optimized for portrait mode operation.

According to an embodiment, the portrait mode alignment parameters account for different aspect ratios between the touchscreen monitor in portrait orientation and the mobile device display. This ensures accurate coordinate mapping in portrait mode regardless of aspect ratio differences.

According to a still further aspect, a touchscreen interface system comprises a mobile device having a display and configured to execute applications, an external touchscreen monitor having a display panel larger than the display of the mobile device and a touch sensor, and a communication interface configured to transmit display content from the mobile device to the external touchscreen monitor, receive touch input data from the external touchscreen monitor, and transmit the touch input data to the mobile device to control the applications on the mobile device, wherein the external touchscreen monitor is configured to display the display content from the mobile device in an enlarged format relative to the display of the mobile device. This system provides an enhanced user interface with enlarged display content and intuitive touch interaction capabilities.

### BRIEF DESCRIPTION OF THE DRAWINGS

FIG. 1 is a block diagram of a system for accessing smartphone functions using a touchscreen monitor.

FIG. 2 is a block diagram of the system where the smartphone is an iOS or Android phone with detailed component connections.

FIG. 3 is a block diagram of a hub that may be used in the system.

FIG. 4 is a communications interface that may be used in the system.

FIG. 5 illustrates an example of an image magnifier connected to a smartphone where both the touchscreen monitor and smartphone are in landscape mode.

FIG. 6 illustrates an example of an image magnifier connected to a smartphone where both the touchscreen monitor and smartphone are in portrait mode.

FIG. 7 is a diagram illustrating landscape mode display alignment with active and inactive display areas.

FIG. 8 is a diagram illustrating portrait mode display alignment with active and inactive display areas.

FIG. 9 is a diagram depicting touch panel alignment dimensions A, B, C, and D for landscape mode coordinate mapping.

FIG. 10 is a diagram depicting touch panel alignment dimensions N, O, P, and Q for portrait mode coordinate mapping.

### DETAILED DESCRIPTION

The following description with reference to the accompanying drawings is provided to assist in a comprehensive understanding of example implementations of systems and methods for accessing smartphone functions using a connected touchscreen monitor.

As used in this disclosure, the term “mobile device” shall be understood to include a smartphone, a tablet, or any other handheld computing device having a touch screen, a processor and input/output interfaces.

As used in this disclosure, “touchscreen monitor” shall be understood to mean a display on an image magnifier, or a touchscreen display on a laptop, desktop, tablet or any other device having a touchscreen or touch panel.

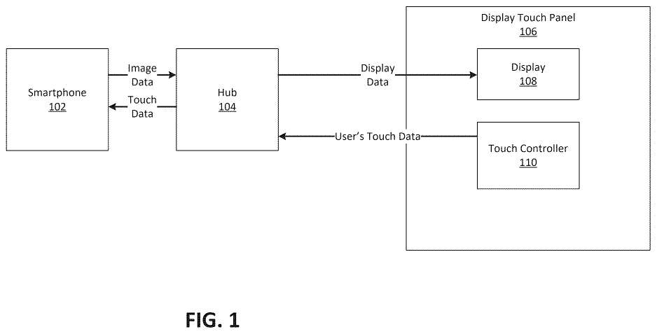

FIG. 1 illustrates an embodiment of a system for accessing mobile device functions using a touchscreen monitor or display touch panel or any display having touch panel functions. The system comprises mobile device 102, hub 104, and display touch panel 106. Mobile device 102 communicates image data to hub 104, which defines the image displayed on the mobile device's touchscreen display. Hub 104 receives this image data and communicates it as display data to display touch panel 106 for presentation on display 108. Examples described below implement the system for use with mobile devices that operate using the iOS™ or the Android™ operating systems. Mobile devices that use other operating systems may be used as well.

The mobile device or smartphone communicates image data to the hub for display on the touchscreen and receives touch data to control the functions of the mobile device. In an example implementation, a user connects the smartphone to the hub, preferably using a standard communications interface that is standard for the smartphone. The hub is connected to, or integrated with, the touchscreen to receive touch data from the touchscreen to communicate to the smartphone, and to send image data from the smartphone to the touchscreen for display to the user. The hub may be a standalone interface device having a port for an interface to the mobile device and one or more ports for an interface with the touchscreen monitor. The hub may also be a component or set of components that are integrated with the mobile device or the touchscreen monitor.

Display touch panel 106 includes display 108 for presenting the image content from mobile device 102 and touch controller 110 for detecting and processing user touch inputs. When a user touches the surface of display touch panel 106, touch controller 110 generates touch data indicating the location of the user's touch input. This touch data is communicated back to hub 104 as “User's Touch Data” and subsequently transmitted to mobile device 102 as “Touch Data” to control functions and applications running on the mobile device 102. In example implementations, the hub 104 may translate the user's touch data to touch data that aligns with the touchscreen panel on the mobile device 102. In this way, the mobile device 102 performs a function corresponding to the functionality invoked by touching the touchscreen on the mobile device 102 at the location indicated by the touch data.

The bidirectional communication between mobile device 102 and hub 104 enables seamless integration between the mobile device and the external touchscreen interface. Hub 104 serves as an intermediary that translates and routes both visual content from the mobile device to the larger display and touch input commands from the external touchscreen back to the mobile device. This configuration allows users to interact with mobile device applications through the larger, more accessible interface of display touch panel 106 while maintaining full functionality of the mobile device.

The system enables users with visual impairments or those requiring larger interface elements to effectively use mobile device applications by providing an enlarged display surface combined with intuitive touch interaction capabilities. The touch controller 110 ensures accurate detection of user inputs on the external touchscreen, which are then precisely mapped to corresponding locations on the mobile device's native touchscreen interface through hub 104.

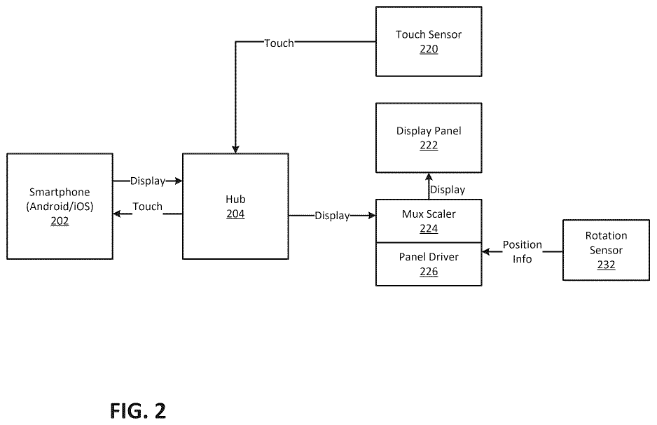

FIG. 2 illustrates an embodiment of the system where mobile device 202 operates an Android or iOS operating system and communicates with hub 204 to enable touchscreen monitor functionality. Mobile device 202 transmits display data to hub 204, which processes and forwards this information to the touchscreen monitor components for presentation and user interaction.

The touchscreen monitor comprises several interconnected components that work together to provide display and touch functionality. Touch sensor 220 is positioned physically on top of display panel 222 to detect user touch inputs on the monitor surface. Display panel 222 receives processed display signals and presents the mobile device content to the user in an enlarged format. A multiplexer/scaler function 224 performs image processing functions including multiplexing functions such as switching between X and Y axes to measure position, switch data signals to specific pixels, scaling the mobile device display content to match the aspect ratio and resolution of the touchscreen monitor, color enhancement, and rotation adjustments.

A panel driver 226, which is shown adjacent to the mux/scaler 224 to represent both as components in a display panel driver, controls the operation of display panel 222 and receives processed image data from the hub 204. The panel driver 226 also outputs display data to the display panel 222.

Rotation sensor 232 detects the physical orientation of the touchscreen monitor and provides position information to the display driver. When the user rotates the touchscreen monitor between portrait and landscape orientations, rotation sensor 232 communicates this change to mux scaler 224, which then adjusts the display resolution and orientation accordingly. For example, the screen resolution may change from 1080×1920 pixels in portrait mode to 1920×1080 pixels in landscape mode to match the physical position of the screen.

The touch sensor 220 detects user touch inputs and communicates touch data back to hub 204, which then forwards this information to mobile device 202. Hub 204 serves as the central communication interface, coordinating the bidirectional data flow between the mobile device and the touchscreen monitor components. This configuration enables users to view enlarged mobile device content on the larger display panel 222 while interacting through touch sensor 220, providing an integrated and accessible user interface experience.

The rotation sensor 232 information is also communicated to mobile device 202 via hub 204 through a data communication channel, allowing the mobile device to adjust its image output to match the current orientation of the touchscreen monitor. This synchronization ensures that the mobile device content is properly oriented regardless of whether the touchscreen monitor is positioned in landscape or portrait mode, providing optimal viewing and interaction experience for the user.

In an example implementation, the touch sensor and/or touch controller communicate touch locations on the touchscreen monitor to the smartphone. The smartphone may then translate the touchscreen location to a touch location on the smartphone based on the difference in aspect ratio between the devices. The smartphone may also adjust the smartphone touch location based on the physical position of the touchscreen monitor (i.e. portrait or landscape).

In another implementation, the touch sensor and/or touch controller may translate the user's touch location on the touchscreen monitor to a corresponding touchscreen location on the smartphone. The touch sensor and/or touch controller may also update the touchscreen location on the smartphone based on the rotation of the touchscreen monitor.

The display on the touchscreen monitor may include an integrated video channel to receive display data from external sources. Such external sources may include, for example, a CCTV input, and other suitable video sources.

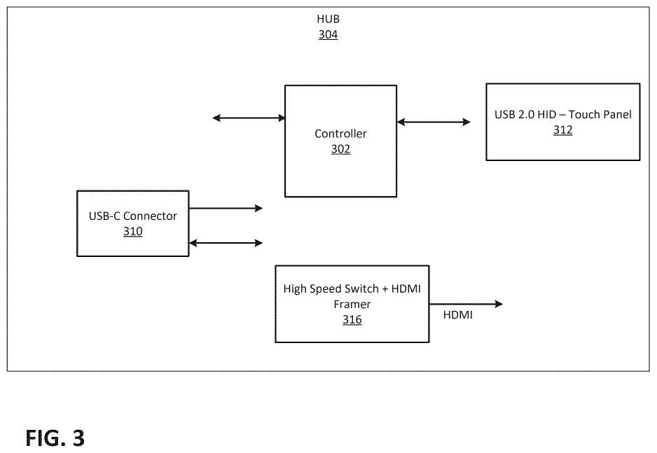

FIG. 3 illustrates an embodiment of a hub 304 that facilitates communication between a mobile device and a touchscreen monitor. The hub 304 comprises several interconnected components that enable bidirectional data transmission for both display content and touch input functionality. The hub serves as a central interface device that coordinates the flow of image data from the mobile device to the external touchscreen monitor and touch data from the touchscreen monitor back to the mobile device.

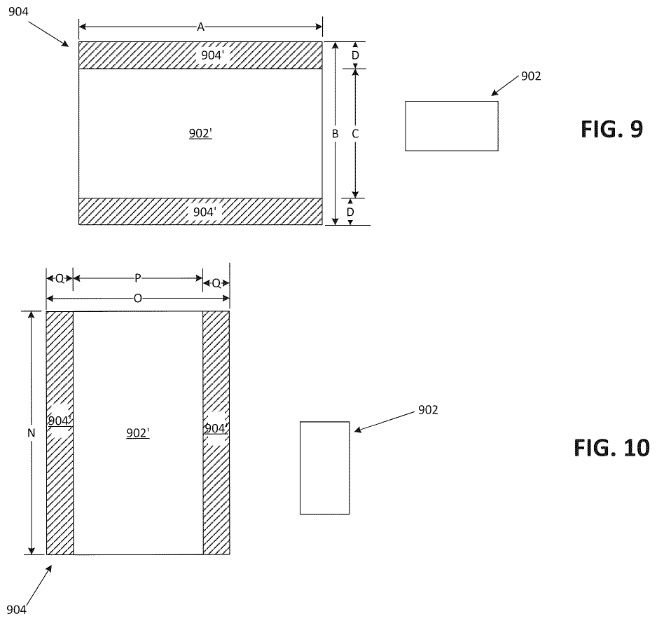

The hub 304 includes a controller 302 to serve as the central processing unit of hub 304 and coordinate communication between all connected components. Controller 302 receives image data from the mobile device via USB-C connector 310 and routes this information to the appropriate output components for display on the touchscreen monitor. Simultaneously, controller 302 receives touch input data from the touchscreen monitor and forwards this information back to the mobile device through USB-C connector 310. In one example, HDMI signals may be communicated via a USB-C connector using HDMI ALT mode, with the USB-C connection to the mobile device configured to communicate touch input data. The controller 302 may receive Extended Display Identification Data (“EDID”) information as defined by the Video Electronics Standards Association (VESA) and use the data to identify a mobile device type as well as its specifications regarding touch screen dimensions, resolution, and aspect ratio, which may be used by the hub 304 to perform touch data alignment correction as described with reference to FIGS. 9 and 10 below.

A USB-C connector 310 provides the primary interface for connecting to the mobile device, utilizing the standardized USB-C connection that is common to both Android and iOS mobile devices. This connector supports both data transmission and power delivery, enabling the mobile device to receive charging power while connected to the hub. USB-C connector 310 communicates bidirectionally with controller 302, which manages the overall operation and data routing within hub 304.

A USB 2.0 HID-Touch Panel 312 implements a Human Interface Device touch panel interface over the USB 2.0 protocol. This component receives touch data from the touchscreen monitor and formats it according to the USB HID specification for transmission to the mobile device. The USB 2.0 interface provides reliable communication of touch coordinates and gesture information, enabling the mobile device to interpret touch inputs from the external touchscreen monitor as if they were occurring on the device's native touchscreen.

A High Speed Switch+HDMI Framer 316 processes the video output from the mobile device and converts it to an HDMI signal for transmission to the touchscreen monitor. This component receives image data from controller 302 and formats it according to HDMI specifications, enabling high-quality digital video transmission to the external display. The high speed switch functionality allows for efficient routing of video data, while the HDMI framer ensures proper signal formatting and timing for compatibility with standard HDMI displays.

The interconnected architecture of hub 304 enables seamless integration between mobile devices and external touchscreen monitors. Controller 302 manages the coordination between USB-C connector 310, USB 2.0 HID-Touch Panel 312, and High Speed Switch+HDMI Framer 316 to provide a unified interface experience. This configuration allows users to view enlarged mobile device content on the external touchscreen monitor while maintaining full touch interaction capabilities, effectively extending the mobile device's interface to a larger, more accessible display surface.

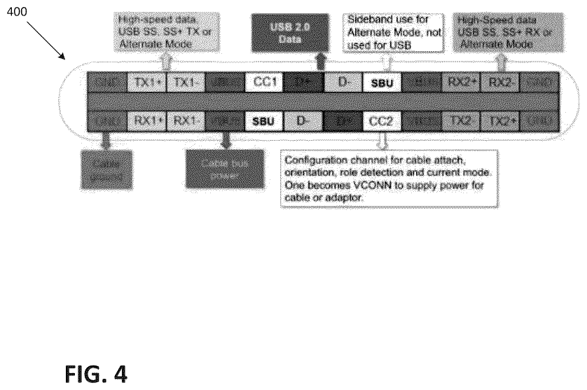

FIG. 4 illustrates an embodiment of a USB-C communications interface 400 that facilitates data transmission between a mobile device and a touchscreen monitor system. The USB-C connector provides multiple communication channels that enable simultaneous transmission of different types of data, including high-speed video data, USB 2.0 touch data, and configuration signals for device negotiation and power management.

The USB-C connector includes dedicated channels for high-speed data transmission, labeled as transmitting “High-speed data, USB SS, SS+TX or Alternate Mode” and receiving “High-speed data USB SS, SS+RX or Alternate Mode”. These channels support alternative mode protocols such as DisplayPort, enabling the transmission of video content from the mobile device to the external touchscreen monitor. The high-speed channels provide sufficient bandwidth for transmitting high-quality video signals while maintaining compatibility with various display resolutions and refresh rates.

USB 2.0 data channels within the connector handle the bidirectional communication of touch input information between the touchscreen monitor and the mobile device. These channels implement the USB Human Interface Device protocol for touch panel functionality, allowing touch coordinates and gesture data to be transmitted from the external touchscreen monitor back to the mobile device. The USB 2.0 interface provides reliable and standardized communication for touch input data while maintaining compatibility across different mobile device platforms.

The interface includes sideband channels designated for “Alternate Mode, not used for USB” functionality, which facilitate device capability negotiation and configuration management. These channels enable the hub to communicate with the mobile device to establish the appropriate data transmission modes and coordinate the setup of alternative mode protocols. Configuration channels handle cable attachment detection, orientation sensing, role detection, and current mode determination, ensuring proper establishment of the connection between devices.

The USB-C connector also incorporates power delivery capabilities, with one configuration channel used to supply power for the cable or adapter components. This power delivery functionality enables the mobile device to receive charging power through the same connection used for data transmission, simplifying the overall system setup and reducing the number of required cables. The integrated power and data transmission through a single USB-C connection provides a streamlined interface that supports both the operational requirements of the touchscreen monitor system and the power needs of the connected mobile device.

The cable bus power and ground connections provide the necessary electrical infrastructure to support both data transmission and power delivery functions. This comprehensive communication interface enables the hub to coordinate all aspects of the mobile device and touchscreen monitor integration, including video output, touch input processing, device configuration, and power management, through a single standardized USB-C connection.

It is noted that the systems, devices and methods described above are examples of systems, devices, and methods for using a touchscreen monitor to use a connected smartphone. The systems, devices, and methods described may be adapted in ways known to those skilled in the art to operate smartphones other than iOS and Android phones, to operate using touchscreen monitors that are standalone, or used in larger computing systems or magnifying devices, and to operate using communication interfaces other than those described here. For example, the communication interface may be wired or wireless, and use interfaces other than those described here.

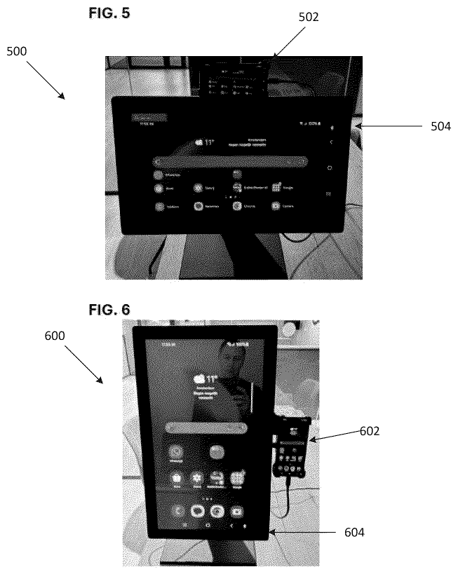

The systems, devices, and methods described above may be incorporated into an image magnifying device to assist low vision users in using their smartphones. FIG. 5 illustrates an embodiment 500 of the system implemented with an image magnifying device where both touchscreen monitor 504 and mobile device 502 are positioned in landscape orientation. FIG. 5 shows touchscreen monitor 504 displaying enlarged content from mobile device 502, which may be held in a cradle or mounting system positioned to the right side of the touchscreen monitor.

In this landscape mode configuration, touchscreen monitor 504 presents the mobile device's display content in an enlarged format that fills the monitor's screen area. The enlarged presentation enables users with visual impairments to more easily view and interact with mobile device applications, social media content, messaging interfaces, and other mobile device functions. The touchscreen monitor 504 maintains the same landscape orientation as mobile device 502, ensuring synchronized display orientation between the devices.

The system enables users to interact directly with the enlarged content displayed on touchscreen monitor 500 rather than attempting to manipulate the small touchscreen interface of mobile device 502. When a user touches an icon, button, or interface element on touchscreen monitor 500, the touch input is detected by the monitor's touch sensor and transmitted through the hub to mobile device 502 as corresponding touch coordinates. This configuration eliminates the disconnect between viewing enlarged content on the large monitor while being required to physically interact with the small mobile device screen.

The landscape orientation shown in FIG. 5 provides optimal viewing for applications and content that are designed for wide-screen presentation, such as video content, web browsing, and certain productivity applications. A cradle or mounting system positions the mobile device 502 in the same orientation as touchscreen monitor 504, ensuring that any orientation-dependent features or sensors in the mobile device remain properly aligned with the display presentation.

This embodiment demonstrates the practical implementation of the touchscreen monitor interface system integrated with assistive technology devices, specifically image magnifiers used by individuals with low vision. The combination of enlarged display presentation and intuitive touch interaction capabilities provides an accessible interface solution that enhances the usability of mobile device functions for users who require visual assistance or larger interface elements.

FIG. 6 illustrates an embodiment 600 of the system implemented with an image magnifying device where both touchscreen monitor 604 and mobile device 602 are positioned in portrait orientation. FIG. 6 demonstrates the system's capability to operate in portrait mode, with touchscreen monitor 604 displaying enlarged mobile device content in a vertical orientation that matches the natural portrait aspect ratio of mobile device 602.

In this portrait mode configuration, touchscreen monitor 604 presents the mobile device's display content in an enlarged vertical format that optimizes the viewing experience for applications designed for portrait orientation. Many mobile device applications, including messaging interfaces, social media feeds, contact lists, and certain productivity apps, are specifically designed to operate in portrait mode and provide optimal user experience when displayed vertically. The enlarged presentation on touchscreen monitor 604 enables users with visual impairments to more easily view and interact with these portrait-oriented applications.

The system maintains synchronized orientation between touchscreen monitor 604 and mobile device 602, ensuring that the display content is properly aligned and that touch inputs are accurately mapped between the devices. When a user touches an interface element on touchscreen monitor 604, the touch coordinates are translated using the portrait mode alignment correction algorithms to generate corresponding touch coordinates on mobile device 602. This coordinate translation accounts for the different aspect ratios and screen dimensions between the touchscreen monitor and mobile device display.

The portrait orientation shown in FIG. 6 provides optimal viewing for content that benefits from vertical screen real estate, such as scrolling through long lists, reading text messages, viewing social media timelines, or navigating through menu systems. The cradle or mounting system positions mobile device 602 in the same portrait orientation as touchscreen monitor 604, ensuring that any orientation-dependent features, sensors, or applications in the mobile device remain properly aligned with the display presentation.

This portrait mode implementation demonstrates the system's flexibility in accommodating different user preferences and application requirements. Users can rotate both the touchscreen monitor and mobile device between landscape and portrait orientations based on the specific content they are viewing or the applications they are using. The rotation sensor in the touchscreen monitor detects orientation changes and communicates this information to the hub and mobile device, enabling automatic adjustment of display parameters and touch coordinate mapping algorithms to maintain accurate functionality in both orientations.

The integration with the image magnifying device provides enhanced accessibility for users with low vision, combining the benefits of enlarged display presentation with intuitive touch interaction capabilities.

It is noted that the display area of the mobile device 502 and 602 in FIGS. 5 and 6 cover the area of the touchscreen panel 504 and 604 in both portrait and landscape mode. This is possible where the aspect ratio and resolution of the touchscreen panel overlaps with that of the display of the mobile device. For certain mobile device models, this may not be the case. In such cases, the alignment of the touch panel of the touchscreen panel may be corrected with that of the mobile device display as described below with reference to FIGS. 9 and 10.

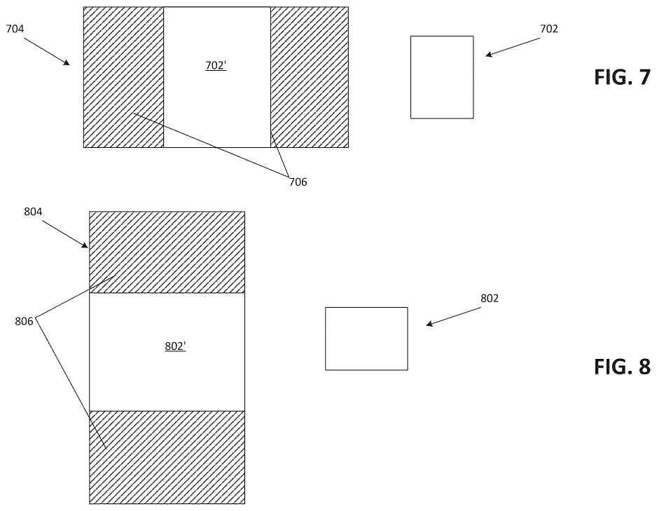

FIG. 7 illustrates an embodiment depicting a touchscreen panel 704 in landscape mode displaying the mobile device 702 in portrait mode orientation. The figure shows touchscreen monitor 704 displaying mobile device content 702′ in portrait orientation, with the active display area surrounded by inactive regions on the side portions of the touchscreen monitor 704 in a hatch pattern.

In the touchscreen panel's landscape mode configuration, mobile device content 702′ occupies the central portion of touchscreen monitor 704, while the hatched regions represent inactive black areas where no mobile device content is displayed. These hatched regions occur due to the difference in aspect ratios between the mobile device display and the touchscreen monitor. The active display area contains the actual mobile device interface elements, applications, and content that users can interact with through touch inputs.

Touch inputs on the active display area of touchscreen monitor 704 are accurately mapped to corresponding coordinates on mobile device 702 using the landscape mode alignment correction algorithms, ensuring precise interaction with mobile device applications and interface elements.

The system automatically detects the landscape orientation through rotation sensors and applies appropriate coordinate translation parameters to maintain accurate touch input mapping. This landscape mode configuration demonstrates the system's capability to provide an enhanced user interface experience while preserving the natural interaction patterns and functionality of the mobile device in its preferred landscape orientation for specific applications and content types.

FIG. 8 an embodiment depicting a touchscreen panel 804 in portrait mode displaying the mobile device 802 in landscape mode orientation. The figure shows touchscreen monitor 804 displaying mobile device content 802′ in portrait orientation, with the active display area surrounded by inactive hatched regions on the top and bottom portions of the touchscreen monitor.

In this portrait mode configuration, mobile device content 802′ occupies the central vertical portion of touchscreen monitor 804, while the hatched regions represent inactive black areas where no mobile device content is displayed. These hatched regions may appear on the display as black regions, which occur due to the difference in aspect ratios between the mobile device display and the touchscreen monitor when the devices are oriented in different modes. The active display area contains the actual mobile device interface elements, applications, and content that users can interact with through touch inputs on the touchscreen monitor.

The portrait mode display alignment shown in FIG. 8 demonstrates the system's capability to handle orientation-specific content presentation and touch input mapping. Touch inputs on the active display area of touchscreen monitor 804 are accurately mapped to corresponding coordinates on mobile device 802 using the portrait mode alignment correction algorithms described in relation to FIG. 10. The coordinate translation accounts for the different aspect ratios and screen dimensions between the touchscreen monitor and mobile device display, ensuring precise interaction with mobile device applications and interface elements.

The system automatically detects the portrait orientation through rotation sensors and applies appropriate coordinate translation parameters to maintain accurate touch input mapping. This portrait mode configuration provides an enhanced user interface experience for applications that are specifically designed for vertical orientation, enabling users with visual impairments to interact with enlarged portrait-oriented content while maintaining the natural functionality and user experience of mobile device applications in their intended orientation.

As noted, certain mobile devices may not have aspect ratios and resolutions that allow for precise mapping of the display on the mobile device with that of the touchscreen panel. For example, different mobile devices such as iPhones™ made by Apple™ may not map precisely with widely available touchscreen panels. FIG. 9 illustrates an embodiment depicting landscape mode touch panel alignment dimensions for coordinate mapping between touchscreen monitor 904 and mobile device 902. The figure shows the dimensional parameters A, B, C, and D that define the coordinate translation system when the touchscreen monitor is oriented in landscape mode. Touchscreen monitor 904 displays mobile device content 902′ in landscape orientation, with the active display area surrounded by inactive black regions 904′ on the top and bottom portions of the touchscreen monitor.

The landscape mode alignment correction system uses parameters A, B, C, and D to accurately translate touch coordinates from the touchscreen monitor to corresponding coordinates on the mobile device display. Parameter A represents the horizontal dimension of the touchscreen monitor display resolution, extending from pixel (0,0) to pixel (A−1, B−1). Parameter B represents the vertical dimension of the touchscreen monitor display resolution. Parameter C defines the scaled vertical dimension used in the coordinate transformation algorithm, while parameter D represents the vertical offset from the top edge of the touchscreen monitor to the beginning of the active display area.

The landscape mode alignment correction may utilize specific parameter tables for different display panel types and mobile device models. Those of ordinary skill in the art would understand that such tables can be generated for specific mobile device models to operate with different display panel types having different resolutions and aspect ratios.

Table 1-Landscape Mode Touch Panel Alignment Table for FHD displays is one example that provides alignment parameters for Full High Definition displays with 1920×1080 resolution to operate with different mobile device types.

TABLE 1
Landscape Mode Touch Panel Alignment Table for FHD displays

| Landscape mode | | | | | | |
|---|---|---|---|---|---|---|
| FHD | | | | A | | B |
| Display resolution | | | | 1920 | | 1080 |
| | type | | | | C | D |
| | 1 | 2796 | 1290 | 885.83691 | 886 | 97 |
| | 2 | 2868 | 1320 | 883.682008 | 884 | 98 |
| | 3 | 2556 | 1179 | 885.633803 | 886 | 97 |
| | 4 | 2622 | 1206 | 883.112128 | 884 | 98 |
| | 5 | 2736 | 1260 | 884.210526 | 886 | 97 |
| | 6 | 2532 | 1170 | 887.203791 | 888 | 96 |

Table 2-Landscape Mode Touch Panel Alignment Table for 2K QHD displays is another example that provides parameters for Quad High Definition displays with 2560×1440 resolution to operate with different mobile device types.

TABLE 2
Landscape Mode Touch Panel Alignment
Table for 2K QHD displays

| Landscape mode | | | | | | |
|---|---|---|---|---|---|---|
| 2K (QHD) | | | | A | | B |
| Display resolution | | | | 2560 | | 1440 |
| | type | | | | C | D |
| | 1 | 2796 | 1290 | 1181.11588 | 1182 | 129 |
| | 2 | 2868 | 1320 | 1178.24268 | 1180 | 130 |
| | 3 | 2556 | 1179 | 1180.84507 | 1182 | 129 |
| | 4 | 2622 | 1206 | 1177.48284 | 1178 | 131 |
| | 5 | 2736 | 1260 | 1178.94737 | 1180 | 130 |
| | 6 | 2532 | 1170 | 1182.93839 | 1184 | 128 |

Table 3-Landscape Mode Touch Panel Alignment Table for 4K QHD displays provides parameters for 4K display s with 3840×2160 resolution to operate with different mobile device types.

TABLE 3
Landscape Mode Touch Panel Alignment
Table for 4K QHD displays

| Landscape mode | | | | | | |
|---|---|---|---|---|---|---|
| 4K (QHD) | | | | A | | B |
| Display resolution | | | | 3840 | | 2160 |
| | type | | | | C | D |
| | 1 | 2796 | 1290 | 1771.67382 | 1772 | 194 |
| | 2 | 2868 | 1320 | 1767.36402 | 1768 | 196 |
| | 3 | 2556 | 1179 | 1771.26761 | 1772 | 194 |
| | 4 | 2622 | 1206 | 1766.22426 | 1768 | 196 |
| | 5 | 2736 | 1260 | 1768.42105 | 1770 | 195 |
| | 6 | 2532 | 1170 | 1774.40758 | 1776 | 192 |

Dimensions A, B, C, and D in Tables 1, 2, and 3 refer to the dimensions shown in FIG. 9.

These parameter tables enable the hub to detect the specific mobile device type through EDID data and apply the corresponding alignment correction values for precise coordinate mapping. The coordinate translation formula a′=a and b′=[(b−D)×B]/C utilizes these predetermined values to ensure accurate touch input mapping between the touchscreen monitor and mobile device display in landscape orientation. Touch inputs within the active display area are processed using these parameters, while touches in black regions outside the active area report null responses to prevent unintended interactions.

When a user touches the touchscreen monitor at coordinates (a, b), the hub applies the landscape mode coordinate translation formulas: a′=a and b′=[(b−D)×B]/C, where (a′, b′) represent the corresponding coordinates on mobile device 902. This mathematical transformation accounts for the different aspect ratios and orientations between the touchscreen monitor and mobile device display, ensuring that touch inputs on the external monitor are accurately mapped to the correct locations on the mobile device interface. The horizontal coordinate remains unchanged (a′=a), while the vertical coordinate undergoes scaling and offset correction to compensate for the aspect ratio differences.

The landscape mode configuration addresses the challenge that arises when the mobile device content is displayed in landscape orientation on a touchscreen monitor that may have a different aspect ratio. The black regions 904′ on the top and bottom portions of the touchscreen monitor represent areas where no mobile device content is displayed due to aspect ratio differences. Touch inputs in these black regions are mapped to null responses to prevent unintended interactions.

This landscape mode alignment system enables users to interact naturally with mobile device applications displayed in landscape orientation while maintaining precise touch coordinate accuracy across different device models and display panel types, including FHD, QHD, and 4K display configurations.

FIG. 10 illustrates an embodiment depicting portrait mode touch panel alignment dimensions for coordinate mapping between touchscreen monitor 904 and mobile device 902 for mobile devices that may not map precisely to the touchscreen monitor. FIG. 10 shows the dimensional parameters N, O, P, and Q that define the coordinate translation system when the touchscreen monitor is oriented in portrait mode. Touchscreen monitor 904 displays mobile device content 902′ in portrait orientation, with the active display area surrounded by inactive hatched regions 904′ on the left and right sides, which the hatched regions may appear black on a display.

The portrait mode alignment correction system uses parameters N, O, P, and Q to accurately translate touch coordinates from the touchscreen monitor to corresponding coordinates on the mobile device display. Parameter N represents the horizontal dimension of the mobile device display in portrait mode, while parameter O represents the vertical dimension. Parameter P defines the scaled dimension used in the coordinate transformation algorithm, and parameter Q represents the vertical offset from the top edge of the touchscreen monitor to the beginning of the active display area.

The portrait mode alignment correction may utilize specific parameter tables for different display panel types and mobile device models.

Table 4-Portrait Mode Touch Panel Alignment Table for FHD displays is one example that provides alignment parameters for Full High Definition displays with 1920×1080 resolution in portrait orientation.

TABLE 4
Portrait Mode Touch Panel Alignment Table for FHD displays

| Portrait mode | | | | N | | O |
|---|---|---|---|---|---|---|
| Display resolution | | | | 1920 | | 1080 |
| | type | | | | P | Q |
| | 1 | 1290 | 2796 | 885.8369 | 886 | 97 |
| | 2 | 1320 | 2868 | 883.6820 | 884 | 98 |
| | 3 | 1179 | 2556 | 885.6338 | 886 | 97 |
| | 4 | 1206 | 2622 | 883.1121 | 884 | 98 |
| | 5 | 1260 | 2736 | 884.2105 | 886 | 97 |
| | 6 | 1170 | 2532 | 887.2038 | 888 | 96 |

Table 5-Portrait Mode Touch Panel Alignment Table for 2K QHD displays is another example table that contains parameters for Quad High Definition displays with 2560×1440 resolution in portrait orientation.

TABLE 5
Portrait Mode Touch Panel Alignment Table for 2K QHD displays

| | | | | N | | O |
|---|---|---|---|---|---|---|
| Display resolution | | | | 2560 | | 1440 |
| | type | 2K (QHD) | | | P | Q |
| | 1 | 1290 | 2796 | 1181.1159 | 1182 | 129 |
| | 2 | 1320 | 2868 | 1178.2427 | 1180 | 130 |
| | 3 | 1179 | 2556 | 1180.8451 | 1182 | 129 |
| | 4 | 1206 | 2622 | 1177.4828 | 1178 | 131 |
| | 5 | 1260 | 2736 | 1178.9474 | 1180 | 130 |
| | 6 | 1170 | 2532 | 1182.9384 | 1184 | 128 |

Table 6-Portrait Mode Touch Panel Alignment Table for 4K QHD displays is another example that provides parameters for 4K displays with 3840×2160 resolution in portrait orientation to operate with different mobile devices.

TABLE 6
Portrait Mode Touch Panel Alignment Table for 4K QHD displays

| 4K (QHD) | | | | N | | O |
|---|---|---|---|---|---|---|
| Display resolution | | | | 3840 | | 2160 |
| | type | | | | P | Q |
| | 1 | 1290 | 2796 | 1771.6738 | 1772 | 194 |
| | 2 | 1320 | 2868 | 1767.3640 | 1768 | 196 |
| | 3 | 1179 | 2556 | 1771.2676 | 1772 | 194 |
| | 4 | 1206 | 2622 | 1766.2243 | 1768 | 196 |
| | 5 | 1260 | 2736 | 1768.4211 | 1770 | 195 |
| | 6 | 1170 | 2532 | 1774.4076 | 1776 | 192 |

Dimensions N, O, P, and Q in Tables 4, 5, and 6 refer to the dimensions shown in FIG. 10.

These parameter tables enable the hub to detect the specific mobile device type through EDID data and apply the corresponding alignment correction values for precise coordinate mapping in portrait mode. The coordinate translation formulas a′=[(b−Q)×N]/P and b′=(a×O)/N utilize these predetermined values to ensure accurate touch input mapping between the touchscreen monitor and mobile device display in portrait orientation. Touch inputs within the active display area are processed using these parameters, while touches in black regions outside the active area report null responses to prevent unintended interactions.

When a user touches the touchscreen monitor at coordinates (a, b), the hub applies the portrait mode coordinate translation formulas: a′=[(b−Q)×N]/P and b′=(a×O)/N, where (a′, b′) represent the corresponding coordinates on mobile device 902. This mathematical transformation accounts for the different aspect ratios and orientations between the touchscreen monitor and mobile device display, ensuring that touch inputs on the external monitor are accurately mapped to the correct locations on the mobile device interface.

The portrait mode configuration addresses the challenge that arises when the mobile device content is displayed in portrait orientation on a touchscreen monitor that may have a different aspect ratio. The black regions 904′ on either side of the active display area represent portions of the touchscreen monitor where no mobile device content is displayed. Touch inputs in these black regions are mapped to null responses to prevent unintended interactions. This portrait mode alignment system enables users to interact naturally with mobile device applications displayed in portrait orientation while maintaining precise touch coordinate accuracy across different device models and display panel types.

The touchscreen monitor and mobile device connectivity system as shown in FIGS. 5-10 may be provided in different configurations. For example:
A stand-alone touchscreen monitor may be mounted on a stand that may allow for rotation, height-adjustment, and viewing angle adjustment. A phone holder may be included to attach the mobile device to the touchscreen monitor, or the mobile device holder may be a part of the structure of the stand.
Another stand-alone configuration with a magnification hardware device linked to also provide live magnification, as well as digital text, and text read aloud by capture of a hard-copy document.
A desktop magnifier product where the magnifier touch screen also serves as the touch screen for the connected phone. The desktop magnifier touch screen can accommodate rotation from landscape to portrait mode for a better user experience where apps are designed to be used in portrait mode only.
A touchscreen monitor that is used as a display device for a computer and provided with connectivity to a smartphone to allow the user to use the touchscreen monitor as the user interface of the smartphone.

In example implementations of some or all of the above optional product configurations, the display may be mounted in an offset bracket that allows for rotation from portrait to landscape (and vice versa) without changing the distance from the lower edge of the monitor to the table surface. The bracket may be positioned so the camera of the phone is facing the user sitting in front of the screen allowing e.g. video call functionality.

The touchscreen monitor and smartphone depicted in FIGS. 5 and 6 may be used in the following manner:
1. A phone is put in the cradle attached to the monitor.
2. The smartphone is connected to the touchscreen monitor via a USB-C cable. Once connected, the smartphone may be in a charging mode.
3. When the smartphone is activated via the on-button and the phone is locked, the smartphone may need to be unlocked either via an on screen pincode or gesture, or an alternative biometric unlocking techniques like a fingerprint scanner or face recognition. The cradle in which the smartphone sits may be positioned to enable easy access for unlocking the smartphone.
4. Once unlocked, the image on the smartphone is displayed on the external touchscreen monitor.
5. The orientation (e.g. landscape or portrait mode) of the image on the smartphone and touchscreen monitor may be synchronized. As the aspect ratio of a phone is different from the aspect ratio of the external touch screen, the aspect ratio may be modified by the mux scaler described above with reference to FIG. 2, and/or other hardware and software functions in the touchscreen monitor or the smartphone to provide an optimum sized mirrored image.
6. The phone orientation and external touch screen orientation are synchronized (EDID based). The Android operating system can set orientation according to EDID protocol. There is an orientation sensor in the monitor. The MUX scaler can read the sensor data and setup the EDID. The MUX scaler will change the touch firmware for the orientation the screen is in.
7. The cradle holding the smartphone on the touchscreen monitor may be configured so as to ensure that the touchscreen monitor and smartphone are in the same orientation. FIGS. 5 and 6 illustrate how a user can readily see that the orientation of the smartphone changes as the touchscreen monitor is rotated from landscape to portrait mode.
8. The screen orientation may be adjusted according to the user's preferences to accommodate some apps or other content that may best be viewed at a specific orientation.
9. When the screen is rotated 90 degrees, a directional sensor inside the touchscreen monitor detects the change in orientation and changes the orientation of the displayed image in relation to the phone orientation.
10. In the rotation process, hardware and/or software functions in the touchscreen monitor change the touch firmware and monitor Extend Device ID (“EDID”) to display the smartphone image on the touchscreen monitor so it fits the touchscreen monitor in the most optimized way.
11. The height and the tilt of the monitor can be adjusted to the user preferences.
12. An external keyboard and/or external mouse can be linked to the phone if that is comfortable for the user. A keyboard can allow for quicker input than an onscreen keyboard.

Using the touchscreen monitor and smartphone connection described above, a user with low vision may use the apps and other functions on their smartphone by viewing and interacting with the touchscreen monitor.

It is understood that various attributes and elements from any one configuration can also be included in other configurations. Although the present disclosure has been described in detail with reference to certain preferred configurations thereof, other versions are possible. The actual scope of the disclosure encompasses not only the disclosed configurations, but also all equivalent ways of practicing or implementing the disclosure. The above detailed description of the configurations of the disclosure is not intended to be exhaustive or to limit the disclosure to the precise form disclosed above or to the particular field of usage mentioned in this disclosure. While specific configurations of, and examples for, the disclosure are described above for illustrative purposes, various equivalent modifications are possible within the scope of the disclosure, as those skilled in the relevant art will recognize. The elements and acts of the various configurations described above may be combined to provide further configurations.

1. A system for accessing mobile device functions using a touchscreen monitor, the system comprising:
a mobile device having a touchscreen display and a processor configured to execute software applications;
a touchscreen monitor having a display panel and a touch sensor configured to detect user touch inputs on the touchscreen monitor;
a hub configured to communicate with the mobile device and the touchscreen monitor, wherein the hub is configured to:
receive image data from the mobile device defining an image displayed on the mobile device touchscreen display;
communicate the image data to the touchscreen monitor for display on the display panel of the touchscreen monitor;
receive touch data from the touchscreen monitor indicating a location of a user touch input on the touchscreen monitor; and
communicate the touch data to the mobile device to control functions of the mobile device.

2. The system of claim 1, wherein the hub comprises a USB-C connector configured to connect to the mobile device.

3. The system of claim 1, wherein the hub comprises a USB controller configured to implement a Human Interface Device touch panel interface over a USB 2.0 interface.

4. The system of claim 1, wherein the hub comprises:
a high-speed switch configured to output an HDMI signal from an alternative mode interface; and
an HDMI framer configured to format the image data for transmission to the touchscreen monitor.

5. The system of claim 1, further comprising a mux scaler configured to translate an aspect ratio of the mobile device display to an aspect ratio of the touchscreen monitor.

6. The system of claim 5, wherein the mux scaler is configured to scale the image data to fit a size of the display panel of the touchscreen monitor.

7. The system of claim 1, wherein the touchscreen monitor comprises a rotation sensor configured to detect rotation of the touchscreen monitor between portrait and landscape orientations.

8. The system of claim 1, wherein the hub is configured to detect orientation changes between landscape and portrait modes and automatically switch between corresponding alignment correction algorithms.

9. The system of claim 1, wherein the hub is configured to translate the user touch input location on the touchscreen monitor to a corresponding touch location on the mobile device based on a difference in aspect ratio between the touchscreen monitor and the mobile device.

10. The system of claim 1, wherein the mobile device is configured to translate the touch data received from the hub to a touch location on the mobile device touchscreen display based on a difference in aspect ratio between the touchscreen monitor and the mobile device.

11. The system of claim 1, wherein the hub is configured to detect a model of the mobile device and apply alignment correction based on the detected model to compensate for differences between mobile device display resolution and touch panel resolution.

12. The system of claim 11, wherein the alignment correction comprises applying scaling factors to translate touch coordinates from the touchscreen monitor to corresponding coordinates on the mobile device based on predetermined alignment parameters for the detected model.

13. The system of claim 12, wherein:
the predetermined alignment parameters include dimension values A, B, C, and D that define active display areas and offset values for different mobile device models and display panel types; wherein the hub is configured to apply different alignment correction algorithms based on display panel type, including Full High Definition (FHD), Quad High Definition (QHD), and 4K display panels; and
wherein the alignment correction algorithm translates touch coordinates (a, b) on the touchscreen monitor to coordinates (a′, b′) on the mobile device using the formula: a′=a and b′=[(b−D)×B]/C, where B, C, and D are predetermined values based on the mobile device model and display panel type.

14. The system of claim 1, wherein the hub comprises a lookup table containing alignment parameters for different mobile device models, the alignment parameters defining coordinate translation between the touchscreen monitor and respective mobile device models.

15. The system of claim 14, wherein the lookup table includes separate parameter sets for landscape mode and portrait mode orientations of the touchscreen monitor.

16. The system of claim 1, wherein:
the hub is configured to apply portrait mode alignment correction using predetermined parameters N, O, P, and Q that define coordinate translation for portrait orientation of the touchscreen monitor; and
wherein the portrait mode alignment correction translates touch coordinates (a, b) on the touchscreen monitor to coordinates (a′, b′) on the mobile device using the formulas: a′=[(b−Q)×N]/P and b′=(a×O)/N.

17. The system of claim 1, wherein the hub comprises separate lookup tables for landscape mode and portrait mode orientations, each table containing alignment parameters specific to the respective orientation and mobile device model.

18. The system of claim 17, wherein the portrait mode lookup table includes parameter sets for different display panel types including FHD (1920×1080), 2K QHD (2560×1440), and 4K QHD (3840×2160) displays in portrait orientation.

19. The system of claim 1, wherein the hub stores portrait mode alignment tables containing different parameter values for a plurality of mobile device types, each type having specific N, O, P, and Q values for coordinate mapping.

20. The system of claim 1, wherein the hub is configured to identify inactive areas in the display content from the touchscreen monitor and map touch inputs in corresponding areas of the mobile device to null responses.
